(19) United States
(12) Patent Application Publication
(10) Pub. No.: US 2011/0176137 A1
(43) Pub. Date: Jul. 21, 2011

(54) Optical Sensor

(75) Inventors: Markus Gerigk, Koln (DE); Andreas Bäcker, Wuppertal (DE); Thomas Birsztejn, Dormagen (DE); Ralf Imhäuser, Langenfeld (DE); Christian Roth, Leverkusen (DE); Walter Speth, Duren (DE); Simon Vougioukas, Koln (DE)

(73) Assignee: BAYER TECHNOLOGY SERVICES GMBH, Leverkusen (DE)

(21) Appl. No.: 13/122,170

(22) PCT Filed: Apr. 17, 2009
(86) PCT No.: PCT/EP2009/002809

§ 371 Date: Apr. 1, 2011

(30) Foreign Application Priority Data
Oct. 11, 2008 (DE) 10 2008 051 409.8

(51) Int. Cl. G01N 21/47; G07D 7/12

(52) U.S. Cl. 356/446

(57) ABSTRACT

The invention relates to an optical sensor for detecting characteristic reflection patterns caused by randomly distributed and/or oriented microreflectors. The invention furthermore relates to the method od using a sensor according to the invention for identifying and/or authenticating objects.

This is an application filed under 35 USC §371 of PCT/EP2009/002809, claiming priority to DE 10 2008 051 409.8 filed on Oct. 11, 2008.

### BACKGROUND OF THE INVENTION

(1) Field of the Invention

The invention relates to an optical sensor for detecting characteristic reflection patterns caused by randomly distributed and/or oriented microreflectors. The invention furthermore relates to the use of a sensor according to the invention for identifying and/or authenticating objects.

For protection against forgery, identity cards, banknotes, products, etc. are nowadays provided with elements which can be copied only with special knowledge and/or high technical outlay. Such elements are referred to here as security elements. Security elements are preferably connected inseparably to the objects to be protected. An attempt to separate the security elements from the object preferably leads to their destruction, in order that the security elements cannot be misused.

The authenticity of an object can be checked on the basis of the presence of one or more security elements.

(2) Description of Related Art

Optical security elements such as e.g. watermarks, special inks, guilloche patterns, microscripts and holograms are established worldwide. An overview of optical security elements which are suitable in particular but not exclusively for document protection is given by the following book: Rudolf L. van Renesse, Optical Document Security, Third Edition, Artech House Boston/London, 2005 (pp. 63-259).

On account of the ready availability and high quality of reproductions which can be created by means of modern colour copiers or by means of high-resolution scanners and colour laser printers, there is a need to constantly improve the forgery security of optical security elements.

Optically variable security elements that produce a different optical impression at different viewing angles are also known. Security elements of this type have optical diffraction structures, for example, which reconstruct different images at different viewing angles. Such effects cannot be reproduced by means of the normal and widespread copying and printing techniques.

One specific embodiment of such a diffraction optical security element is described in DE10126342C1. A so-called embossed hologram is involved in this case. Embossed holograms are distinguished by the fact that the light-diffracting structure is converted into a three-dimensional relief structure that is transferred to an embossing die. Said embossing die can be embossed as a master hologram in plastic films. It is thus possible to produce a large number of security elements cost-effectively. What is disadvantageous, however, is that security elements produced in this way always have the same embossed hologram. The embossed holograms cannot be differentiated. This means, firstly, that a forger only has to copy/forge a single master hologram to obtain a multiplicity of embossed holograms for forged products. Secondly, objects cannot be individualized by the embossed holograms on account of the indistinguishability thereof.

For reasons of better protection against forgery and the possibility of tracking and identifying individual objects, it is preferable to use security elements that permit individualization.

DE102007044146A1 describes a transparent thermoplastic material into which so-called metal identification laminae having a maximum length extent of less than 200 μm and a thickness of 2-10 μm are introduced. The material can be used as a security element in the form of films in card-type data carriers such as e.g. identity cards. The metal identification laminae can have through holes and diffractive structures. DE102007044146A1 describes that the authenticity of an object can be checked by viewing the metal identification laminae under a microscope.

What is disadvantageous about checking authenticity by means of a microscope is the high outlay. For uninterrupted coverage of the supply chain it is necessary that the authenticity can be verified rapidly and reliably at different locations.

Optical codes such as e.g. barcodes are usually used for product tracking (track and trace). In this case, barcodes are purely features for identifying and tracking an object, which have no security features whatsoever. They are simple to copy and forge. A combination of features for product tracking and for protection against forgery is afforded by RFID chips, but the latter can be used only to a limited extent on account of their comparatively high costs, slow read-out speed and sensitivity to electromagnetic interference fields. It would be desirable, therefore, to be able to read a security element by machine in order, firstly, to enable automated product tracking along the supply chain and, secondly, also to be able to perform authenticity checking by machine.

Proceeding from the prior art, the object is to provide a device which enables an object to be identified and/or authenticated on the basis of individual features. The device should be able to be used for product tracking. The device should be simple and cost-effective to produce, intuitive and simple to handle, flexibly usable and extendable, yield reproducible and transferrable results and be suitable for series production.

It has surprisingly been found that the materials described in DE102007044146 A1 can be unambiguously identified and authenticated on the basis of the random distribution and/or orientation of the metal identification laminae. For this purpose, the metal identification laminae are irradiated with electromagnetic radiation. The radiation reflected at the randomly distributed and/or oriented metal identification laminae at different angles is detected by means of suitable detectors. The reflection pattern thus obtained is characteristic of the random distribution and/or orientation of the metal identification laminae and permits the unambiguous identification and/or authentication of an object to which the metal identification laminae are connected. This is described in detail in the application PCT/EP/2009/000450, which has not yet been published and to which reference is hereby made. In the application PCT/EP/2009/000450 metal identification laminae are generally referred to as microreflectors.

### BRIEF SUMMARY OF THE INVENTION

The present invention relates to a sensor for detecting a characteristic reflection pattern caused by irradiation of an object comprising randomly distributed and/or oriented microreflectors.

The sensor according to the invention comprises at least the following components:
a source for electromagnetic radiation, which is arranged in such a way that electromagnetic radiation can be transmitted onto the object at an angle α,
a photodetector for picking up reflected radiation, which is arranged in such a way that the radiation reflected from the object at an angle δ is detected,
   characterized in that the magnitudes of the angles α and δ are different (|α|≠|δ|).

The sensor according to the invention is embodied in such a way that electromagnetic radiation can be transmitted onto a surface of an object at an angle α. The angle α relates to the normal to the surface, that is to say to a straight line perpendicular to the surface of the object—also referred to as surface normal hereinafter. The angle α lies in the range of 0 to 60°, preferably in the range of 15° to 40°, particularly preferably in the range of 20° to 35°, and especially preferably in the range of 25° to 30°.

As a source for electromagnetic radiation or radiation source for short, in the sensor according to the invention it is possible to use in principle all sources for electromagnetic radiation which emit such radiation which is at least partly reflected by the microreflectors used. Partial reflectivity is understood to mean a reflectivity of at least 50%, that is to say that at least 50% of the radiation intensity radiated in is reflected by the microreflectors.

If the microreflectors are embedded in a material, then the electromagnetic radiation used has to be able at least partly to penetrate through the material, that is to say that the material has to be at least partly transparent to the electromagnetic radiation used. Partial transparency is understood to mean a transmissivity of at least 50%, that is to say that at least 50% of the radiation intensity radiated in penetrates through the material.

The radiation source preferably emits electromagnetic radiation in the range of 300 nm to 1000 nm, preferably in the range of 350 nm to 800 nm.

The sensor according to the invention comprises 1 to 6 radiation sources, preferably 1 to 4 radiation sources, particularly preferably 1 or 2 radiation sources.

With regard to a compact and cost-effective design of the sensor according to the invention and a large signal-to-noise ratio, laser diodes are preferred as radiation source. Laser diodes are generally known; they are semiconductor components in which a p-n junction with high doping is operated at high current densities. The choice of the semiconductor material determines the wavelength emitted. Laser diodes that emit visible radiation are preferably used.

Lasers of class 1 or 2 are particularly preferably used. Classes are understood to mean the laser protection classes in accordance with the standard DIN EN 60825-1: lasers are classified in classes according to dangerousness to eyes and skin. Class 1 includes lasers whose irradiation values lie below the maximum permissible irradiation values even upon continuous irradiation. Class 1 laser scanners are not dangerous and, apart from the corresponding identification on the apparatus, require no further protective measures whatsoever. Class 2 includes lasers in the visible range for which an irradiation having a duration of less than 0.25 ms is not harmful to the eye (the duration of 0.25 ms corresponds to an eyelid closing reflex that can automatically protect the eye against longer irradiation). In a particularly preferred embodiment, class 2 laser diodes having a wavelength of between 600 nm and 780 nm are used.

The sensor according to the invention is embodied in such a way that the electromagnetic radiation reflected from the object at one or more angles can be detected by means of one or more photodetectors.

For detecting reflection patterns, the sensor according to the invention is moved at a constant distance relative to an object comprising microreflectors. In this case, the object is irradiated by means of electromagnetic radiation. Since the surface of the object directly reflects part of the radiation, according to the invention no photodetectors lie in the region of the radiation reflected from the surface. This is because the radiation reflected directly from the surface of the object is so intense that additional reflections from microreflectors can be identified only with difficulty or can no longer be identified at all. In order to increase the signal-to-noise ratio, the photodetectors lie, rather, in a region in which they detect the reflected radiation from those microreflectors whose reflective surfaces do not lie parallel to the surface of the object. The detection of such microreflectors whose reflective surfaces do not lie parallel to the surface of the object additionally has the advantage that forgeries with e.g. vapour-deposited metal spots, which always lie parallel to the surface of the object, can be reliably identified. The position of the reflective surface with respect to a surface of the object is also referred to here as orientation.

In accordance with the law of reflection, electromagnetic radiation that is incident on the surface of the object at an angle α of incidence with respect to the surface normal is reflected from the surface at an angle β of reflection with respect to the surface normal, where |α|=|β|, that is to say that the magnitudes of angle α of incidence and angle β of reflection are identical. According to the invention, at least one photodetector is arranged at an angle δ with respect to the surface normal, wherein the magnitudes of the angles α and δ are different (|α|≠|δ|).

Preferably, photodetectors in the sensor according to the invention are arranged at an angle γ around the directly reflected beam. The size of the angle γ is dependent on the choice of the size of the angle α. The size of the angle γ lies in the range of 5° to 60°, preferably in the range of 5° to 30°, particularly preferably in the range of 10° to 20°, wherein the following are always intended to hold true: |α|−γ≧0 and |α|+γ≦90°.

It follows from this that the magnitude of the angle δ lies in the range of |α|±5° to |α|±60°, preferably in the range of |α|±5° to |α|±30°, particularly preferably in the range of |α|±10° to |α|±20°, wherein it is always the case that δ≧0 and δ≦90° hold true.

The number of photodetectors in the sensor according to the invention is 1 to 6 per radiation source, preferably 1 to 4 per radiation source, particularly preferably 1 to 2 per radiation source.

In one preferred embodiment, two photodetectors arranged at an angle γ₁ and γ₂ around the beam reflected directly from the surface are used per radiation source. γ₁=−γ₂ preferably holds true. The photodetectors and the associated radiation source preferably lie in one plane.

The photodetectors used in the sensor according to the invention can be in principle all electronic components that convert electromagnetic radiation into an electrical signal. With regard to a compact and cost-effective design of the sensor according to the invention, photodiodes or phototransistors are preferred. Photodiodes are semiconductor diodes that convert electromagnetic radiation at a p-n junction or pin junction into an electric current by means of the internal photoelectric effect. A phototransistor is a bipolar transistor which has a pnp or npn layer sequence and whose pn junction of the base-collector depletion layer is accessible to electromagnetic radiation. It is similar to a photodiode with a connected amplifier transistor.

The sensor according to the invention has optical elements that produce a linear beam profile. The term optical elements denotes those components which are arranged in the beam path between a source for electromagnetic radiation and at least one photodetector and are used for altering the beam profile (focusing, beam shaping). In particular, they are lenses, diaphragms, diffractive optical elements and the like.

A beam profile is understood to mean the two-dimensional intensity distribution in cross section. That cross section which lies in the plane in which microreflectors are situated is preferably used for the characterization of the beam profile. In one preferred embodiment, the cross section lies at the focal point of the sensor.

The intensity is highest at the cross-sectional centre of the beam and decreases outwards. In this case, the gradient of the intensity in the case of a linear beam profile is lowest in a first direction, while it is at its highest in a second direction, running perpendicular to the first direction. The intensity distribution of the linear beam profile is preferably symmetrical, such that the cross-sectional profile at the focal point can be characterized by two mutually perpendicular axes, of which one runs parallel to the highest intensity gradient and the other runs parallel to the lowest intensity gradient.

The width of a cross-sectional profile—or else beam width—is understood hereafter to mean that distance from the centre of the cross-sectional profile in the direction of the lowest intensity gradient at which the intensity has fallen to half its value at the centre.

Furthermore, the thickness of a cross-sectional profile—or else beam thickness—is understood to mean that distance from the centre of the cross-sectional profile in the direction of the highest intensity gradient at which the intensity has fallen to half its value at the centre.

The beam width and the beam thickness are preferably adapted to the size and concentration of the microreflectors in the material whose reflection pattern is intended to be detected. In this case, the beam thickness is preferably of the order of magnitude of the average size of the microreflectors. The beam width is preferably of the order of magnitude of the average distance between two microreflectors.

An average size is understood to mean the arithmetic mean. Order of magnitude is understood to mean that two sizes deviate from one another by a factor of less than 10 and greater than 0.1 or are identical.

In one preferred embodiment of the sensor according to the invention, the beam width lies in the range of 2.5 mm to 7 mm, preferably in the range of 3 mm to 6.5 mm, particularly preferably in the range of 4 mm to 6 mm, and especially preferably in the range of 4.5 mm to 5.5 mm.

The beam thickness lies in the range of 5 μm to 1000 μm. In order to obtain a large signal-to-noise ratio and in order to resolve fine structures, a small beam thickness of 5 μm to 50 μm is advantageous. As the size of the cross-sectional profile that is incident on the object decreases, the signal-to-noise ratio increases since the intensity is distributed over a smaller area. As the size of the cross-sectional profile decreases, even finer structures can be resolved. It has been found empirically that as the size of the cross-sectional profile decreases, it becomes increasingly difficult, however, to obtain reproduceable signals. This is apparently owing to the fact that the material with the microreflectors can no longer be positioned sufficiently accurately relative to the diminishing cross-sectional profile. It apparently becomes increasingly difficult to hit the region sufficiently accurately upon renewed detection of the reflection pattern. In the case of a beam focused onto the object, the preferred beam thickness lies in the range of 5 μm to 50 μm, preferably in the range of 10 μm to 40 μm, particularly preferably in the range of 20 μm to 30 μm. The focal point preferably lies at a distance of 0.5 to 10 mm from the sensor.

It has surprisingly been found that the abovementioned ranges for the beam thickness and the beam width are very well suited to obtaining the positioning that is sufficiently accurate for the reproducibility, on the one hand, and to obtaining a signal-to-noise ratio that is sufficient for a sufficiently accurate authentication, on the other hand.

There are further aspects which can influence the choice of beam width and beam thickness. Thus, a very compact design of the sensor according to the invention can be realized by dispensing with focusing of the beam by means of lenses. Instead, a linear beam profile is produced by means of a diaphragm. This preferred embodiment is shown in FIG. 5. Here the beam thickness lies in the range of 200 μm to 1000 μm, preferably in the range of 200 μm to 400 μm and the beam width lies in the range of 2 mm to 5 mm, preferably in the range of 2.5 mm to 3.5 mm.

The sensor according to the invention preferably has means for connecting a plurality of sensors or for connecting a sensor to a mount.

These means permit two or more sensors to be connected to one another in a predetermined manner. Preferably, the sensor has positive connecting means on one side and negative connecting means on an opposite side, such that a sensor can be connected on both sides to a respective further sensor in a defined manner, wherein the further sensors can in turn be connected, on the sides still free, to in turn further sensors. This modular principle permits the combination of a multiplicity of sensors in a predefined manner. Positive connecting means that are taken into consideration include projections, for example, which can be inserted into cutouts as negative connecting means. Further connecting means known to the person skilled in the art, such as insertion rails or the like, are conceivable. A plurality of sensors are preferably connected to one another in such a way that the beam widths of all the sensors are arranged along a line.

The connection of two or more sensors is effected in a reversible manner, that is to say that it is releasable. The connecting means can also be used to fit the sensor according to the invention to a mount.

The connection of a variety of sensors affords the following advantages:
As a result of the connection of a plurality of sensors it is possible, with the duration for a detection remaining the same, to record more reflection data and thus to increase the security during identification and/or authentication.
Instead of one surface region of an object to be authenticated in a time interval, in the case of connected sensors a plurality of regions are irradiated in the same time interval and reflected radiation is detected. Accordingly, larger amounts of data which characterize the object are recorded. This increases the accuracy with which one object from a large number of similar objects can be reliably identified and authenticated.
The releasable combination according to the invention of a plurality of sensors affords the user the possibility of reacting flexibly to the respective application. If a higher security is required during identification and/or authentication, then two or more sensors can be connected to one another and, in a simple manner, larger amounts of data can be detected in a time interval that remains the same. By contrast, if e.g. only a simple check of authentication is called for, an individual sensor can be used.
As a result of the connection of a plurality of sensors it is possible to detect a plurality of objects simultaneously. By way of example, it is possible to install a multiplicity of sensors in a production installation. Products are transported at a high speed e.g. by means of a conveyor belt. In order to be able to identify and/or authenticate these products at a later point in time, the characteristic reflection patterns have to be detected and stored e.g. in a database. For this purpose, it is advantageous to connect a plurality of sensors in order to increase the throughput during detection. It is conceivable to connect the sensors to one another by means of spacers if the products are so far apart that they can no longer be individually detected by sensors that are directly connected to one another. The connecting means make it possible to connect the sensors to one another in such a way that they assume a defined position with respect to one another. As a result, the reproduceability during data acquisition is increased and the individual products can be reliably identified and/or authenticated at a later point in time.

The present invention likewise relates to a device comprising two or more sensors that are reversibly connected to one another directly or by means of a spacer.

In one preferred embodiment of the sensor according to the invention, the sensor has a housing, into which the optical components are introduced. Further components, e.g. the control electronics for a laser, signal preprocessing electronics, complete evaluation electronics and the like, can be introduced into the housing of the sensor. The housing preferably also serves for anchoring a connecting cable by which the sensor according to the invention can be connected to a control unit and/or a data acquisition unit for controlling the sensor and/or for detection and further processing of the characteristic reflection patterns.

The sensor preferably also has a window which, together with the housing, protects the optical components against damage and contamination. The window is at least partly transparent to the wavelength of the radiation source used.

The sensor according to the invention is suitable in combination with a control and data acquisition unit for identifying and/or authenticating objects. Consequently, the present invention also relates to the use of the sensor according to the invention in a method for identifying and/or authenticating an object.

Identifying is understood to mean a process that serves for unambiguously recognizing a person or an object. Authenticating is understood to mean the process of checking (verifying) an asserted identity. Authenticating objects, documents, persons or data is ascertaining that the latter are authentic—that is to say that they are originals that are unaltered, not copied and/or not forged.

The object which is intended to be identified and/or authenticated comprises microreflectors which are fitted to the object and/or introduced in the object and are randomly distributed and/or oriented. In this case, the microreflectors themselves can be connected to the object. It is likewise possible to introduce microreflectors into a security element (e.g. a label) that is connected preferably irreversibly to the object. Examples of such security elements are described in DE102007044146A1 or in the application PCT/EP2009/000450, not yet laid open.

A microreflector is characterized in that it comprises at least one surface which reflects radiated-in electromagnetic radiation in a characteristic manner. The characteristic reflection is characterized in that electromagnetic radiation having at least one wavelength is reflected in at least one direction predefined by the angle of incidence, wherein the proportion of the reflected radiation having the at least one wavelength is greater than the sum of the proportions of the absorbed and transmitted radiation having the at least one wavelength. The reflectance of the at least one surface is accordingly greater than 50%, wherein reflectance should be understood to mean the ratio of the intensity of the electromagnetic radiation having at least one wavelength which is reflected from the surface relative to the intensity of the electromagnetic radiation having the at least one wavelength which impinges on the surface. Such a surface is referred to hereinafter as a reflective surface.

The reflective surface of a microreflector has a size of between 1*10⁻¹⁴ m² und 1*10⁻⁵ m². Preferably, the size of the reflective surface lies in the range of between 1*10-12 m² und 1*10⁻⁶ m², particularly preferably between 1*10⁻¹⁰ m² und 1*10⁻⁷ m².

In one preferred embodiment, the microreflectors have a maximum length extent of less than 200 μm and a thickness of 2-10 μm, with a round, elliptical or n-gonal shape where n≧3. Here and hereinafter, elliptical should not be understood in the strictly mathematical sense. A rectangle or parallelogram or trapezium or generally n-sided figure having rounded corners shall here and hereinafter likewise be understood as elliptical.

In one preferred embodiment, the microreflectors contain at least one metallic component. A metal from the series aluminium, copper, nickel, silver, gold, chromium, zinc, tin or an alloy composed of at least two of the metals mentioned is preferably involved. The microreflectors can be coated with a metal or an alloy or be completely composed of a metal/alloy.

In one preferred embodiment, metal identification laminae as described by way of example in WO 2005/078530 A1 are used as microreflectors. They have reflective surfaces. If a multiplicity of such metal identification laminae are randomly distributed and/or oriented in a transparent layer, a characteristic reflection pattern arises upon irradiation of the transparent layer, which pattern can be used for identification and authentication.

Random distribution and/or orientation is understood to mean that the position of individual microreflectors and/or the orientation of individual microreflectors within the transparent layer cannot be set in a foreseeable manner by means of the production process. The methods for producing a thermoplastic material containing microreflectors as described in DE102007044146A1 are suitable for producing a random distribution and/or orientation of microreflectors in a transparent layer. The position and/or orientation of individual microreflectors is subject to random fluctuations during the production process. The position and/or the orientation of individual microreflectors therefore cannot be reproduced in a simple manner.

The high protection afforded by such security elements is based on this fact: they can be reproduced only with very high outlay.

In this case, random should not be understood in the strictly mathematical sense. Random means that there is a random component which makes exact predictability of the position and orientation of individual microreflectors impossible. It is conceivable, however, for microreflectors to have a preferred position and/or orientation. A distribution which can be determined by the production process is established around this preferred position and/or preferred orientation. The position and/or orientation of individual microreflectors remains uncertain, however.

The microreflectors have the property that they reflect electromagnetic radiation having at least one wavelength if an arrangement comprising a source for electromagnetic radiation, at least one reflective surface of at least one microreflector and a detector for the reflected electromagnetic radiation obeys the law of reflection.

The method for authenticating an object comprises at least the following steps:

(A) orienting the object relative to the sensor,
(B) irradiating at least part of the object with electromagnetic radiation,
(C) detecting the radiation reflected at microreflectors,
(D) changing the relative position of the object relative to the sensor,
(E) if appropriate multiply repeating steps (B), (C) and (D),
(F) comparing the reflection pattern detected depending on the relative position with at least one desired pattern,
(G) outputting a notification about the authenticity of the object depending on the result of the comparison in step (F).

Preferably, the object to be authenticated and/or the sensor are moved with respect to one another in order that the microreflectors flashing at different locations and/or at different orientation angles are recorded as a function of the relative position of the object relative to radiation source (laser) and photodetectors.

The change in position can be effected continuously at constant speed, in accelerating fashion or in decelerating fashion, or discontinuously, that is to say e.g. in stepwise fashion.

The repetition of steps (B), (C) and (D) in step (E) is performed until a sufficient number of microreflectors have been detected. This sufficient number is predefined by the respective application. If there are a multiplicity of different objects, each individual one of which is intended to be authenticated reliably, that is to say with a probability of e.g. more than 99%, then the reflection patterns of the individual objects have to be sufficiently differentiated. The probability of the reflection patterns from two different objects being identical decreases with the number of microreflectors which are detected for recording a reflection pattern. In this respect, the number of objects to be differentiated and the reliability with which an object is intended to be authenticated determine the number of microreflectors to be detected.

During authentication, a so-called 1:1 matching between the currently detected reflection pattern and the reflection pattern of the supposed object (desired pattern) takes place in step (F). The reflection pattern represents the reflections from microreflectors that are detected in a manner dependent on the position of the object relative to the sensor. The reflection pattern is therefore present e.g. in the form of a numerical table in which the intensities of the radiation reflected from microreflectors, said intensities being measured at different locations at different angles, are registered. Such a numerical table can be compared directly with a desired numerical table. It is likewise possible to create a different representation of a reflection pattern from the measured intensity distribution by means of mathematical operations before a comparison with a desired pattern is carried out.

It is conceivable, during authentication, firstly to determine the identity of the object for example on the basis of a barcode connected to the object, and then, by means of the comparison between the currently measured reflection pattern and the reflection pattern which is assigned to the identified object, to confirm the correctness of the assignment.

The sensor can likewise be used to directly identify an object on the basis of its characteristic reflection pattern. A method of identifying an object with the aid of the sensor according to the invention comprises at least steps (A) to (G) that have already been discussed for the authentication method in the embodiments discussed there, wherein in step (G) a notification about the identity of the object is effected instead of a notification about the authenticity:
(G) outputting of a notification about the identity of the object depending on the result of the comparison in step (F).

In step (F) of the method according to the invention, the reflection pattern of the object under consideration is compared with reflection patterns that have already been determined at an earlier point in time. In this respect, the identity of an object is determined by means of the reflection pattern and a matching of the reflection pattern under consideration with all the reflection patterns—stored in a database—of objects that have already been detected is effected (1:n-matching).

The use of the sensor according to the invention affords the advantage that identification and/or authentication of an object can be performed by machine or supported by machine and enables a quantitative assessment of the probability with which an object corresponds to an asserted object. Machine performance or support permits the checking of a larger number of objects on the basis of their characteristic reflection patterns in a shorter time and with lower costs than a (purely) person-based performance e.g. with the aid of a microscope as described in DE102007044146A1. Furthermore, machine performance or machine support permits a comparison of reflection patterns which were authenticated at different times. The tracking of objects (track and trace) is thereby made possible.

### BRIEF DESCRIPTION OF THE SEVERAL VIEWS OF THE DRAWING(S)

The invention is explained in more detail below on the basis of a concrete exemplary embodiment, but without restricting the invention thereto.

In the figures:

FIGS. 1a, 1b show a preferred embodiment of the sensor according to the invention without optical components in a perspective illustration

FIG. 2 shows a block of the sensor according to the invention in cross section

FIG. 3 shows a housing with cover

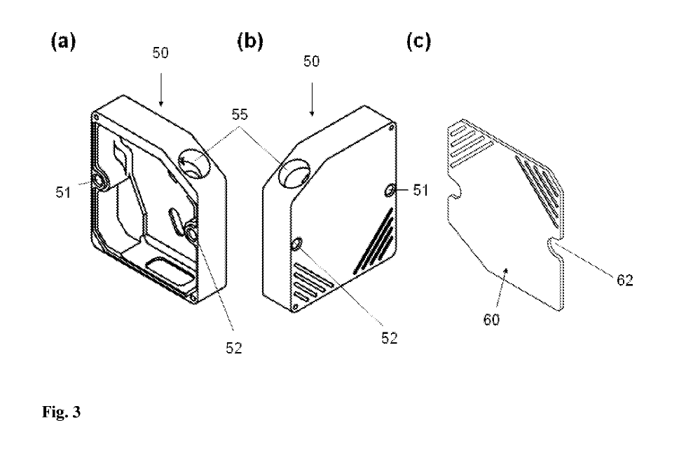

FIG. 4 shows a schematic illustration of a linear beam profile

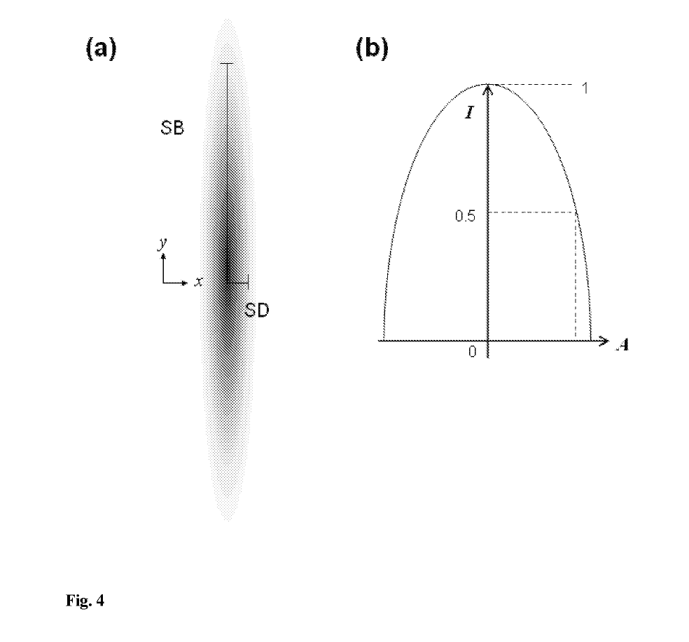

FIG. 5 shows a schematic illustration of a preferred embodiment of the sensor according to the invention

FIG. 6 shows a planoconvex cylindrical lens for producing a linear beam profile

### DETAILED DESCRIPTION OF THE INVENTION

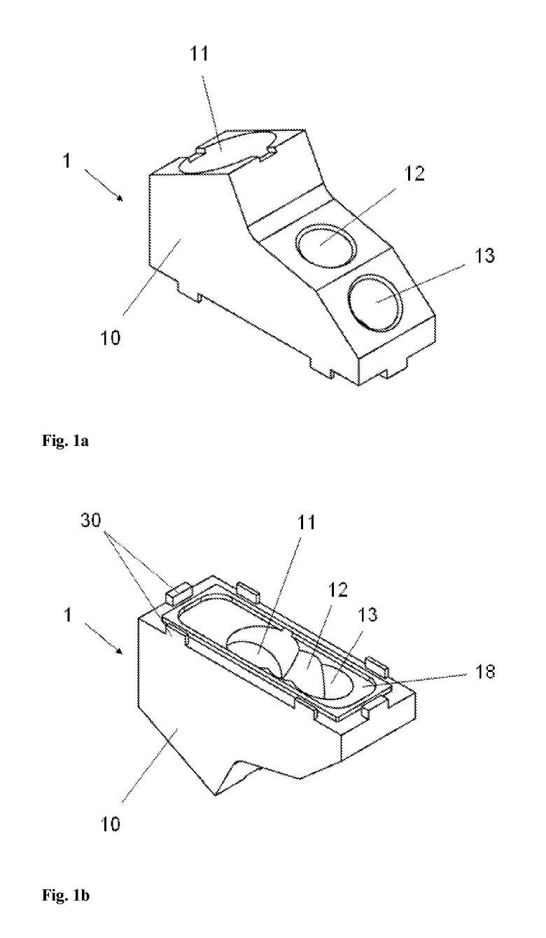

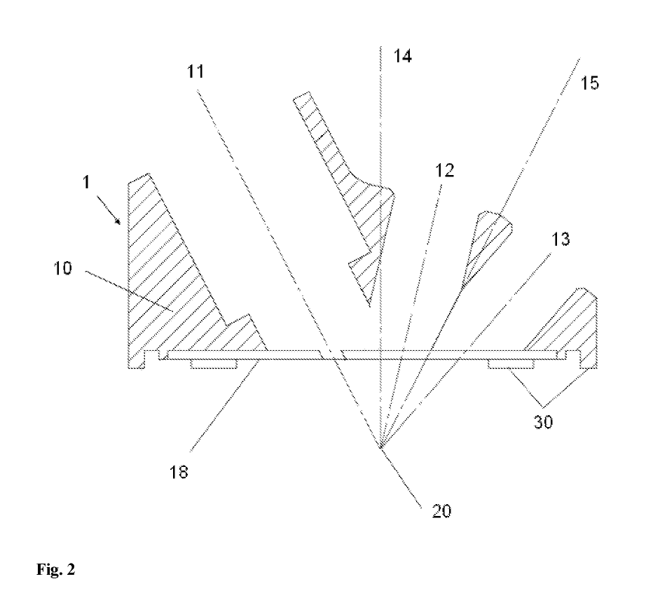

FIGS. 1a and 2b show a sensor 1 according to the invention without optical components in a perspective illustration. FIG. 2 shows the sensor 1 from FIGS. 1a and 1b in cross section.

The central element of the sensor 1 is formed by a block 10, which is preferably embodied in one or two pieces and which serves for receiving all the optical components of the sensor according to the invention.

Optical components are understood to mean all components of the sensor which are arranged in the beam path between radiation source and photodetector, including the laser and the photodiodes themselves. Optical elements form a selection of the optical components; they serve for beam shaping and focussing. In particular, lenses, diaphragms, diffractive optical elements and the like are referred to as optical elements.

The optical block 10 comprises an identified outer surface 18, which is directed at the object during the detection of characteristic reflection patterns of said object. The block 1 comprises bushings 11, 12, 13, which run towards one another in the direction of the identified outer surface 18—referred to simply as outer surface hereinafter. A first bushing 11 serves to receive the radiation source. This bushing 11 runs at an angle α_{A} with respect to the normal to the outer surface. The normal to the outer surface, or outer surface normal for short, is the straight line which is perpendicular to the outer surface and which is directed in the direction of the bushings.

The angle α_{A} lies in the range of 0 to 60°, preferably in the range of 15° to 40°, particularly preferably in the range of 20° to 35°, and especially preferably in the range of 25° to 30°. In the present example, the angle α_{A}=27°.

When using the sensor according to the invention for identifying and/or authenticating an object, the sensor is preferably oriented relative to the surface of the object in such a way that the surface of the object and the outer surface run parallel to one another. In this case, electromagnetic radiation is incident on the surface of the object at an angle α with respect to the surface normal. In this case, the angle α_{A} corresponds to the angle α of incidence of the incident radiation.

Part of the incident radiation is directly scattered back at the surface at an angle β of reflection with respect to the surface normal. In accordance with the law of reflection, α=−β holds true.

According to the invention, at least one photodetector is arranged at an angle γ with respect to the angle β of reflection. For this purpose, the block of the sensor according to the invention comprises at least one further corresponding bushing 12, 13 for receiving the photodetector.

The block of the sensor according to the invention can comprise further bushings for receiving photodetectors. In the particularly preferred embodiment shown, the block comprises precisely two bushings 12, 13 for receiving photodetectors. These lie together with the bushing 11 for the radiation source in one plane. They preferably run at an angle γ₁ and γ₂ with respect to the outer surface normal. The photodetectors are arranged in the bushings in such a way that they are directed towards the outer surface. The angles γ₁ and γ₂ lie in the range of 5° to 60°, preferably in the range of 5° to 30°, particularly preferably in the range of 10° to 20°, where the following is always intended to hold true: α−γᵢ≧0, α+γᵢ≦90° for i=1 and i=2. In the present example, the angles are γ₁=−13.5° and γ₂=13.5°.

All of the bushings 11, 12, 13 preferably lie in one plane.

The embodiment of the sensor according to the invention which is shown in FIGS. 1a, 1b and 2, comprising a block with bushings for receiving a radiation source and two photodetectors, affords the advantage that the optical components can be arranged in a simple manner but nevertheless in a defined manner with respect to one another. Preferably, a stop is situated in the bushing for the radiation source. The radiation source is pushed into the bushing against said stop, such that it assumes a predefined fixed position relative to the block and the two further bushings. If the radiation source has optical elements for beam shaping and focussing that are already connected to it, which is generally customary for example in the case of the laser radiation sources that are commercially available nowadays, then as a result of the fixing of the radiation source, at the same time the focal point of the radiation source is unambiguously fixed. The further bushings for receiving photodetectors can likewise be provided with a stop, wherein the position of the photodetectors has to be less accurate than the position of the radiation source.

The block 10 can be produced in one or two pieces from plastic in a simple manner e.g. by means of injection-moulding methods. Components can be produced with high accuracy in large numbers and in a short time by means of injection-moulding methods. This enables cost-effective series production of sufficiently precise components. The bushings can already be provided in the injection mould or subsequently be introduced into the block by means of e.g. drilled holes. Preferably, all the constituent parts of the block are already produced in one step in the injection-moulding method. It is likewise conceivable to mill the block for example from aluminium or plastic and to realize the bushings by means of drilled holes. Further methods for producing a block with defined bushings which are known to the person skilled in the art are conceivable.

The sensor 1 according to the invention is furthermore characterized in that the central axes of the bushings 11, 12, 13 intersect at a point 20 lying outside the block 10 (see FIG. 2). It has surprisingly been found that it is advantageous for the detection of reflection patterns if the intersection point 20 of the central axes lies at a distance of 0.5 to 10 mm from the outer surface. In one preferred embodiment, the intersection point 20 is simultaneously the focal point of the radiation source.

In order to detect reflection patterns produced by microreflectors in the surface of an object, the sensor according to the invention is correspondingly led at a distance over said object, such that the intersection point of the central axes lies on the surface of the object.

In the case of the abovementioned distance range of 0.5 to 10 mm, the positioning of that surface of an object which is to be detected relative to the radiation source and the photodetectors is possible in a simple and sufficiently accurate manner. With an increasing distance between sensor and object, the angle of the sensor relative to the surface of the object has to be complied with increasingly accurately in order to be able to detect a predefined region of the surface, with the result that the requirements made of the positioning increase.

Furthermore, the radiation intensity decreases with increasing distance from the radiation source, such that with an increasing distance between sensor and object, the correspondingly reduced radiation intensity arriving at the object would have to be compensated for by a higher power of the radiation source. However, the sensor according to the invention is preferably equipped with a Class 1 or 2 laser, in order to be able to operate the sensor without extensive protective measures. This holds true particularly because the sensor is “open” (that is to say that the laser beam emerges unimpeded from the sensor). This means that the power of the radiation source cannot be increased arbitrarily. In this respect, a short distance according to the invention of 0.5 to 10 mm is advantageous.

The block 10 in FIGS. 1a, 1b and 2 furthermore comprises holding means 30 for receiving and fixing a window. The window (not illustrated in the figure) is at least partly transmissive to the wavelength of the radiation source used. Partial transmissivity is understood to mean a transmissivity of at least 50%, that is to say that 50% of the radiation intensity radiated in penetrates through the window.

Subfigures 3(a) and 3(b) show a housing 50 in perspective illustration, into which the sensor from FIGS. 1, 1b and 2 can be introduced. Subfigure 3(c) shows a cover 60 associated with the housing. The housing has bushings 51, 52. The bushings can be used as connecting means in order to releasably connect a plurality of sensors to one another or in order to fix the sensor to a mount. The cover 60 has corresponding cutouts 62. Via a cable bushing 55, the sensor is connected to control electronics and/or a computer unit for recording the reflection data.

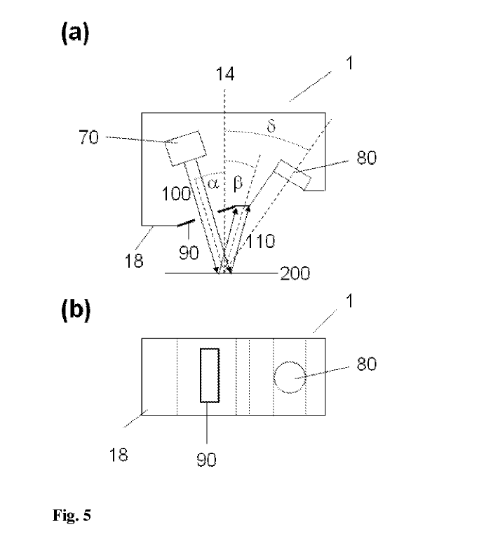

FIG. 5 shows a further preferred embodiment of the sensor 1 according to the invention in a schematic illustration. FIG. 5(a) shows the sensor from the side in cross section, and FIG. 5(b) shows the sensor from the underside facing the surface 200.

The sensor 1 comprises a radiation source 70 and a photodetector 80. If the outer surface 18 of the sensor 1 is led parallel over the surface 200 of an object, then radiation 100 is incident on the surface 200 at an angle α with respect to the normal 14. The radiation 110 reflected at the surface 200 is returned at an angle β with respect to the normal 14. In accordance with the law of reflection, |α|=|β| holds true. The reflected radiation 110 does not impinge on the photodetector 80, since the latter is arranged according to the invention in such a way that the magnitudes of the angles α and β are different (|α|≠|δ|).

In the present example, the linear beam profile is produced by means of a diaphragm 90. The distance between the sensor (outer surface 18) and object (surface 200) is preferably between 0.2 and 10 mm.

Subfigures 4(a) and 4(b) illustrate a linear beam profile having a beam width SB and a beam thickness SD. Subfigure 4(a) illustrates the two-dimensional cross-sectional profile of a beam at the focal point. The highest intensity is present at the centre of the cross-sectional profile. The intensity I decreases outwards, wherein there is a first direction (x), in which the intensity I decreases to the greatest extent with increasing distance A from the centre, and a further direction (y), which is perpendicular to the first direction (x), in which the intensity I decreases to the weakest extent with increasing distance A from the centre. Subfigure 4(b) shows the intensity profile I as a function of the distance A from the centre. The beam width and the beam thickness are defined as the distances from the centre at which the intensity I has fallen to 50% of its maximum value at the centre, wherein here the beam width lies in the y-direction and the beam thickness lies in the x-direction.

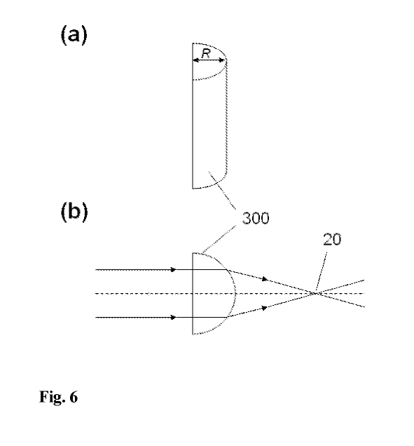

FIG. 6 shows by way of example how a linear beam profile can be produced with the aid of a planoconvex cylindrical lens 300. The cylindrical lens 300 acts as a converging lens (FIG. 6(b)) in one plane. In the plane perpendicular thereto, said lens has no refractive effect. In the coaxial approximation, the following formula holds true for the focal length f of such a lens:

$$f = \frac{R}{n - 1} \qquad Equ . 1$$

where R is the cylinder radius and n is the refractive index of the material.

### REFERENCE SYMBOLS

1 Sensor
10 Block
11 Bushing
12 Bushing
13 Bushing
14 Normal to the outer surface
15 Angle of reflection
18 Outer surface
20 Focal point
30 Holding element
50 Housing
51 Bushing, connecting means
52 Bushing, connecting means
55 Cable bushing
60 Cover
62 Cutout
70 Radiation source
80 Photodetector
90 Diaphragm
100 incident beam
110 reflected beam
200 Surface
300 planoconvex cylindrical lens
α Angle of incidence
βAngle of reflection

1. A sensor for detecting reflection patterns produced by randomly distributed and/or oriented microreflectors in or on an object upon irradiation, comprising
a source for electromagnetic radiation, arranged such that electromagnetic radiation is transmitted onto the object at an angle α,
a photodetector for picking up reflected radiation, arranged such that the radiation reflected from the object at an angle δ is detected,
wherein the magnitudes of the angles α and β are different (|α|≠|δ|).

2. The sensor according to claim 1, wherein the angle α lies in the range of 0 to 60°.

3. The sensor according to claim 2, wherein the magnitude of the angle δ lies in the range of |α|±5° to |α|±60°, wherein it is always the case that δ≧0 and δ≦90° are intended to hold true and the angle δ is relative to the normal to the surface of the object.

4. The sensor according to claim 3, wherein the sensor comprises a number n=1 to 4 of radiation sources and two photodetectors per radiation source, wherein the respective two photodetectors are arranged with a respective radiation source in one plane, wherein the respective two photodetectors detect the beams reflected from the object at the angles δ₁=|α|+γ and δ₂=|α|−γ, wherein γ lies in the range of 5° to 60°, and wherein the following are always intended to hold true: |α|−γ≧0 and |α|+γ≦90°.

5. The sensor according to claim 4, furthermore comprising optical elements for producing a linear beam profile.

6. The sensor according to claim 5, wherein the linear beam profile has a beam thickness in the range of 5 μm to 50 μm.

7. The sensor according to claim 6, wherein the focal point of the radiation lies at a distance in the range of 0.5 mm to 10 mm from the sensor.

8. The sensor according to claim 5, wherein a beam width in the range of 2 mm to 5 mm, and with a beam thickness in the range of 200 μm to 1000 μm, is produced by means of a diaphragm at the distance of 0.5 mm to 10 mm from the sensor.

9. The sensor according to claim 8, further comprising a block embodied in one or two pieces, having a first bushing for receiving a source for electromagnetic radiation and two further bushings for receiving photodetectors.

10. The sensor according to claim 9, further comprising connecting means for connecting a sensor to further sensors or to a mount.

11. A device comprising two or more sensors according to claim 1, which are releasably connected to one another directly or by means of spacers.

12. A method for using a sensor for detecting reflection patterns produced by randomly distributed and/or oriented microreflectors in or on an object upon irradiation for identifying and/or authenticating one or more objects on the basis of the random distribution and/or orientation of microreflectors, the method comprising the steps of
providing a source for electromagnetic radiation, arranged such that electromagnetic radiation is transmitted onto the object at an angle α,
providing a photodetector for picking up reflected radiation, arranged such that the radiation reflected from the object at an angle δ is detected,
wherein the magnitudes of the angles α and δ are different (|α|≠|δ|).

13. The method of using the sensor according to claim 12, wherein the beam width and the beam thickness are adapted to the concentration and size of the microreflectors, wherein the beam thickness is preferably of the order of magnitude of the average size of the microreflectors and the beam width is of the order of magnitude of the average distance between two microreflectors.

14. The method of using the sensor according to claim 12, wherein the sensor or the device is led at a distance of 0.5 mm to 10 mm over a surface of the object.

15. The method of using the sensor according to claim 12, comprising the following steps:
(A) orienting the object relative to the sensor or the device,
(B) irradiating at least part of the object with electromagnetic radiation,
(C) detecting the radiation reflected at microreflectors,
(D) changing the relative position of the object relative to the sensor or the device,
(E) if appropriate multiply repeating steps (B), (C) and (D),
(F) comparing the reflection pattern detected depending on the relative position with at least one desired pattern,
(G) outputting a notification about the identity and/or authenticity of the object depending on the result of the comparison in step (F).

16. The sensor according to claim 2, wherein the angle α lies in the range of 15° to 40° relative to the normal to that surface of the object which is irradiated.

17. The sensor according to claim 2, wherein the angle αlies in the range of 20° to 35° relative to the normal to that surface of the object which is irradiated.

18. The sensor according to claim 2, wherein the angle α lies in the range of 25° to 30° relative to the normal to that surface of the object which is irradiated.

19. The sensor according to claim 3 wherein the magnitude of the angle δ lies in the range of |α|±5° to |α|±30°, wherein it is always the case that δ≧0 and δ≦90° are intended to hold true and the angle δ is relative to the normal to the surface of the object.

20. The sensor according to claim 3, wherein the magnitude of the angle δ lies in the range of |α|±10° to |α|±20°, wherein it is always the case that δ≧0 and δ≦90° are intended to hold true and the angle δ is relative to the normal to the surface of the object.

21. The sensor according to claim 4, wherein γ lies in the range of 5° to 30° and wherein the following are always intended to hold true: |α|−γ≧0 and |α|+γ≦90°.

22. The sensor according to claim 4, wherein γ lies in the range of 10° to 20°, and wherein the following are always intended to hold true: |α|−γ≧0 and |α|+γ≦90°.

23. The sensor according to claim 4, wherein the sensor comprises a number n=1 to 2 of radiation sources and two photodetectors per radiation source, wherein the respective two photodetectors detect the beams reflected from the object at the angles δ₁=|α|+γ and δ₂=|α|−β wherein γ lies in the range of 5° to 30°, and wherein the following are always intended to hold true: |α|−γ≧0 and |α|+γ≦90°.

24. The sensor according to claim 20, wherein γ lies in the range of 10° to 20°.

25. The sensor according to claim 6, wherein the linear beam profile has a beam thickness in the range of 10 μm to 40 μm and a beam width in the range of 2.5 mm to 7 mm.

26. The sensor according to claim 6, wherein the linear beam profile has a beam thickness in the range of 20 μm to 30 μm, and a beam width in the range of 3 mm to 6.5 mm.

27. The sensor according to claim 6, wherein the linear beam profile has a beam thickness in the range of 20 μm to 30 μm, and a beam width in the range of 4 mm to 6 mm.

28. The sensor according to claim 6, wherein the linear beam profile has a beam thickness in the range of 20 μm to 30 μm, and a beam width in the range of 4.5 mm to 5.5 mm.

29. The sensor according to claim 8, wherein a beam width is in the range of 2.5 mm to 3.5 mm and the beam thickness is in the range of 200 μm to 400 μm.
